(19) United States
(12) Patent Application Publication
(10) Pub. No.: US 2023/0133602 A1
(43) Pub. Date: May 4, 2023

(54) DOOR-STEP TIME ESTIMATION AND DELIVERY ROUTE OPTIMIZATION

(71) Applicant: Walmart Apollo, LLC, Bentonville, AR (US)

(72) Inventors: Abhijeet Rajendra Phatak, Sunnyvale, CA (US); Chittaranjan Tripathy, Sunnyvale, CA (US); Nitishkumar Gopu, Sunnyvale, CA (US); Srujan Sai Varma Alluri, San Jose, CA (US); Aaron Martin John Sharpe, Shipley (GB); Christopher Grierson, Kellington, Yorkshire (GB); Karan Khurana, Foster City, CA (US); Chandrasekar Ramalingam, Cupertino, CA (US); Ioannis Pavlidis, Boulder, CO (US)

(21) Appl. No.: 17/906,026

(22) PCT Filed: Jun. 29, 2020
(86) PCT No.: PCT/US2020/040148

§ 371 Date: Sep. 9, 2022

(51) Int. Cl. G06Q 10/0835; G01C 21/34; G06Q 10/047; G06Q 10/0833

(52) U.S. Cl. CPC G06Q 10/08355; G01C 21/3407; G06Q 10/047; G06Q 10/0833

(57) ABSTRACT

An approach generates a speed profile for one or more delivery locations. The speed profile corresponds to location data of a delivery order for a respective delivery location, and indicates a plurality of events associated with a movement of a delivery order to the respective delivery location. The approach generates, based on the speed profile and location data corresponding to the delivery order, feature data of the respective delivery location. The approach applies a machine learning model to the generated feature data to output a door-step time prediction for the respective delivery location. The door-step time prediction is based on a time difference between timestamps of two events of the plurality of events associated with the movement of the delivery order. The approach generates a planned delivery route for the one or more delivery locations, based on the one or more delivery locations and respective the door-step time predictions.

### TECHNICAL FIELD

The disclosure relates generally to transportation logistics, and more particularly, to optimizing delivery routes.

### BACKGROUND

In some instances, a customer may place an order on a retailer's e-commerce website, after which the retailer may deliver the purchased goods to the customer. Some transportation logistics systems may allow the customer to select a delivery window specifying a range of times when the goods may be delivered. When an order is placed, the retailer's associate gathers the purchased goods from a warehouse or store and loads the goods on a delivery vehicle. A delivery associate, e.g., a human or fully automated robot, may deliver the purchased goods to the customer at a specified delivery location, such as to the customer's home, and within the delivery window.

When planning a shipment of orders for a delivery vehicle or a fleet of delivery vehicles, conventional transportation logistics systems may account for door-step time (DST) for the last mile delivery of each order. Last mile delivery may refer to the delivery of an order from a transportation facility, e.g., a warehouse or store, to the order's final destination, e.g., a customer's home. DST may be the period of time the delivery associate spends at the doorstep of a customer during the delivery. However, these conventional systems may not accurately determine or factor in DST for last mile deliveries. Inaccurate DST may cause the transportation logistics system to incorrectly and/or inconsistently configure the delivery routes, which in turn leads to delivering the goods outside the customer's selected delivery window, longer routes, and an increased amount of time to deliver the goods. For example, overestimation of DST may lead to underutilization of last mile resources, such as delivery vehicles and associates, and therefore, route planner may accept fewer orders as the planner does not know the DST is overestimated. In another example, underestimation of DST may lead to stress on operations, in particular delivery associates, thereby, forcing delivery associates to work in unaccounted DST from transit time from other parts of the planned delivery route. Additionally, if certain goods, such as frozen, chilled, or ambient goods, are delayed and not refrigerated in time, these goods may spoil. One or more of these issues may lead to lost business opportunities, and thus, loss of revenue. Moreover, lost business opportunities, and thus serving less customers, has a down-stream impact on the route planner's efficiency, slot optimization, and execution of other areas of last mile deliveries.

### SUMMARY

The summary of the disclosure is given to aid understanding of transportation logistics, and more particularly, delivery route optimization, and not with an intent to limit the disclosure. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the systems, devices, and their methods of operation to achieve different effects. Certain aspects of the present disclosure provide a system, method, and non-transitory computer readable medium for DST estimation and/or delivery route optimization.

In one or more aspects, the disclosed technology relates to a system that comprises a memory having instructions stored thereon, and a processor configured to read the instructions. In one or more cases, the processor is configured to read the instructions to generate a speed profile for one or more delivery locations. In one or more cases, the speed profile corresponds to location data of a delivery order for a respective delivery location. In one or more cases, the speed profile indicates a plurality of events associated with a movement of a delivery order to the respective delivery location. In one or more cases, the processor is configured to read the instructions to generate, based on the speed profile and location data corresponding to the delivery order, feature data of the respective delivery location. In one or more cases, the processor is configured to read the instructions to apply a machine learning model to the generated feature data to output a door-step time prediction for the respective delivery location. In one or more cases, the door-step time prediction is based on a time difference between timestamps of two events of the plurality of events associated with the movement of the delivery order. In one or more cases, the processor is configured to read the instructions to generate a planned delivery route for the one or more delivery locations, based on the one or more delivery locations and the respective door-step time predictions.

In one or more other aspects, the disclosed technology relates to a method. In one or more cases, the method comprises generating a speed profile for one or more delivery locations. In one or more cases, the speed profile corresponds to location data of a delivery order for a respective delivery location. In one or more cases, the speed profile indicates a plurality of events associated with a movement of a delivery order to the respective delivery location. In one or more cases, the method comprises generating, based on the speed profile and location data corresponding to the delivery order, feature data of the respective delivery location. In one or more cases, the method comprises applying a machine learning model to the generated feature data to output a door-step time prediction for the respective delivery location. In one or more cases, the door-step time prediction is based on a time difference between timestamps of two events of the plurality of events associated with the movement of the delivery order. In one or more cases, the method comprises generating a planned delivery route for the one or more delivery locations, based on the one or more delivery locations and the respective door-step time predictions.

In yet one or more other aspects, the disclosed technology relates to a computer program product. In one or more cases, the computer program product comprises a non-transitory computer readable medium having program instructions stored thereon. In one or more cases, the program instructions may be executable by one or more processors. In one or more cases, the program instructions comprise generating a speed profile for one or more delivery locations. In one or more cases, the speed profile corresponds to location data of a delivery order for a respective delivery location. In one or more cases, the speed profile indicates a plurality of events associated with a movement of a delivery order to the respective delivery location. In one or more cases, the program instructions comprise generating, based on the speed profile and location data corresponding to the delivery order, feature data of the respective delivery location. In one or more cases, the program instructions comprise applying a machine learning model to the generated feature data to output a door-step time prediction for the respective delivery location. In one or more cases, the door-step time prediction is based on a time difference between timestamps of two events of the plurality of events associated with the movement of the delivery order. In one or more cases, the program instructions comprise generating a planned delivery route for the one or more delivery locations, based on the one or more delivery locations and respective the door-step time predictions

### BRIEF DESCRIPTION OF THE DRAWINGS

The features and advantages of the present disclosure will be better understood when read in conjunction with the figures provided. Embodiments are provided in the figures for the purpose of illustrating aspects, and/or features, of the various embodiments, but the claims should not be limited to the precise arrangements, structures, features, aspects, methods, processes, assemblies, systems, or devices shown, and the arrangements, structures, features, aspects, methods, processes, assemblies, systems, and devices shown may be used singularly or in combination with other arrangements, structures, features, aspects, methods, processes, assemblies, systems, and devices.

FIG. 1 is a functional block diagram of a data processing environment, in accordance with one or more embodiments.

FIG. 2 is a functional block diagram illustrating components of the data processing environment of FIG. 1, in accordance with one or more embodiments.

FIG. 3 is a flowchart illustrating a process of delivery route optimization, in accordance with one or more embodiments.

FIG. 4 illustrates an example raw data of a delivery order.

FIG. 5 illustrates an example graph illustrating an example speed profile for the delivery order.

FIG. 6 illustrates an example delivery route between two locations.

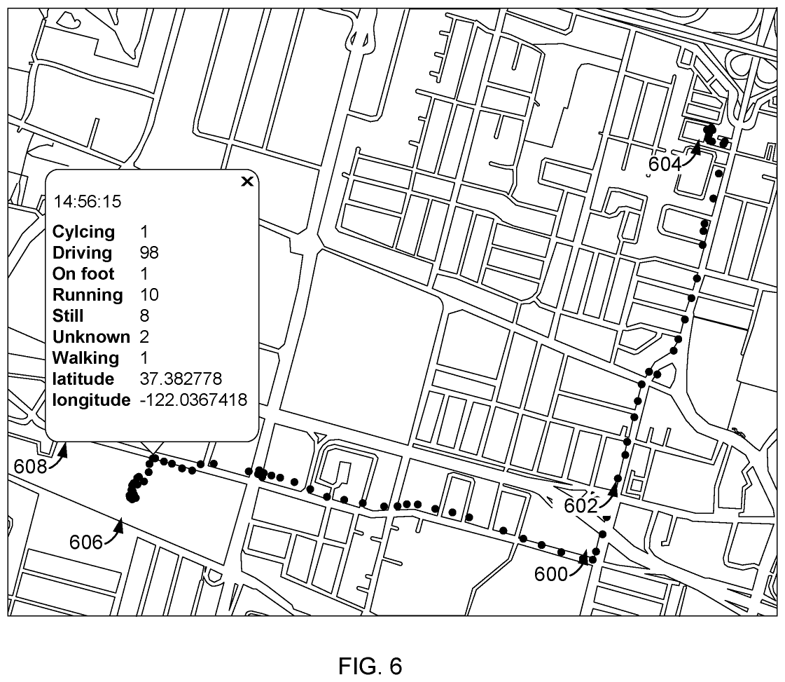

FIG. 7 depicts a block diagram of components of a computing device capable of performing the processes described herein, in accordance with one or more embodiments.

FIG. 8 illustrates example measurements of generated feature data.

### DETAILED DESCRIPTION

The following discussion omits or only briefly describes conventional features of the data processing environment, which are apparent to those skilled in the art. It is noted that various embodiments are described in detail with reference to the drawings, in which like reference numerals represent like drawing elements throughout the figures. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. The objectives and advantages of the claimed subject matter will become more apparent from the following detailed description of these embodiments in connection with the accompanying drawings.

Unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

Embodiments of the disclosure relate generally to transportation logistics, and more particularly to delivery route optimization. Embodiments that optimize delivery routes are described below with reference to the figures.

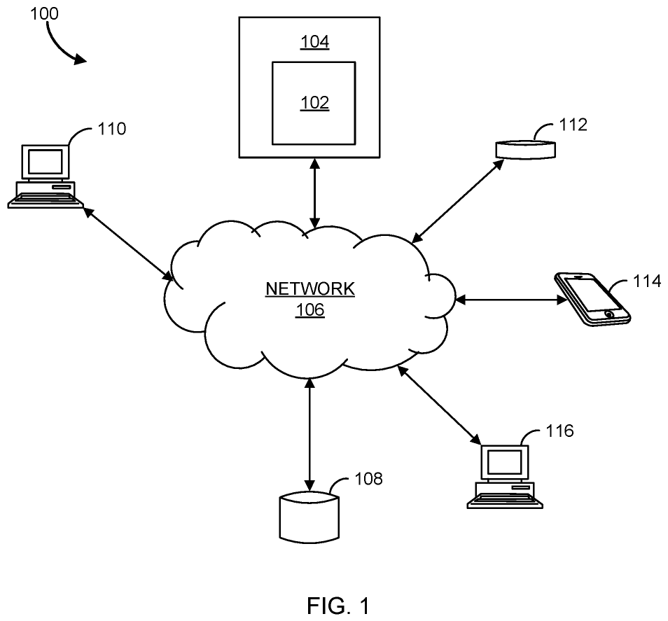

FIG. 1 is a functional block diagram of a data processing environment 100. FIG. 1 provides only an illustration of one implementation and does not imply any limitations with regard to the environments in which different embodiments may be implemented. Many modifications of the depicted environment may be made by those skilled in the art without departing from the scope of the claims. In one or more cases, the data processing environment 100 includes a server 104, which operates a route optimization system 102 (hereinafter “system 102”), a data storage repository 108, a location detector 112, and one or more computing devices, such as computing device 110, computing device 114, and computing device 116 coupled over a network 106. The server 104, system 102, data storage repository 108, and computing devices 110, 114, and 116 can each be any suitable computing device that includes any hardware or hardware and software combination for processing and handling information, and transmitting and receiving data among the server 104, system 102, data storage repository 108, and computing devices 110, 114, and 116. The location detector 112 can be any suitable computing device that includes a global positioning system (GPS) and any hardware or hardware and software combination for determining and tracking a location of the location detector 112, and/or recording a timestamp of the location of the location detector 112. The location detector 112 can include any hardware or hardware and software combination for transmitting GPS coordinates, e.g., longitude and latitude coordinates, and corresponding timestamps to the server 104, system 102, and/or data storage repository 108.

The server 104, system 102, data storage repository 108, location detector 112, and computing devices 110, 114, and 116 can each include one or more processors, one or more field-programmable gate arrays (FPGAs), one or more application-specific integrated circuits (ASICs), one or more state machines, digital circuitry, and any other suitable circuitry capable of implementing one or more features of process 300 as described herein.

The network 106 interconnects the server 104, the data storage repository 108, the location detector 112, and one or more of the devices 110, 114, and 116. In general, the network 106 can be any combination of connections and protocols capable of supporting communication between the server 104, the data storage repository 108, the location detector 112, one or more of the computing devices 110, 114, and 116, and the system 102. For example, the network 106 may be a WiFi® network, a cellular network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. In one or more cases, the network 106 may include wire cables, wireless communication links, fiber optic cables, routers, switches, firewalls, or any combination that can include wired, wireless, or fiber optic connections.

In one or more cases, the server 104 hosts the system 102. In some cases, the server 104 may be a web server, a blade server, a mobile computing device, a laptop computer, a tablet computer, a netbook computer, a personal computer (PC), a desktop computer, or any programmable electronic device or computing system capable of receiving and sending data, via the network 106, and performing computer-readable program instructions. In one or more examples, the server 104 hosts a website, such as an e-commerce website, for a retailer to sell goods and for a customer to purchase a good via one or more web pages of the e-commerce website. For example, a user of a computing device, such as the computing device 116, may access a web page, add one or more goods to an online shopping cart, and perform an online checkout of the shopping cart to purchase the goods. In another example, the server 104 may be configured to receive location, speed, and timestamp data from the location detector 112 and provide the location, speed, and timestamp data to the system 102. In other cases, the server 104 can be a data center, which includes a collection of networks and servers, such as virtual servers and applications deployed on virtual servers, providing an external party access to the system 102. In some other cases, the server 104 represents a computing system utilizing a distributed computing system of clustered computers and components (e.g., database server computer, application server computers, etc.) that act as a single pool of seamless resources, such as in a cloud computing environment, when accessed within data processing environment 100.

In one or more cases, the data storage repository 108 may store data including, but not limited to, location data, speed data, timestamp data corresponding to the location data and/or speed data, customer address data, order history data, customer history data, door-step time data, planned route data, feature data, timestamp data corresponding to when an ignition of a delivery vehicle is turned on and/or turned off, timestamp data corresponding to when an order was delivered, speed profiles, and other data as described herein. In one or more cases, the data storage repository 108 may be one of, a web server, a mobile computing device, a laptop computer, a tablet computer, a netbook computer, a personal computer (PC), a desktop computer, or any programmable electronic device or computing system capable of receiving, storing, sending data, and performing computer readable program instructions capable of communicating with the server 104, and computing devices 110, 114, and 116, via network 106. In one or more cases, the data storage repository 108 may represent virtual instances operating on a computing system utilizing clustered computers and components (e.g., database server computer, application server computers, etc.) that act as a single pool of seamless resources when accessed within data processing environment 100. In one or more cases, the data storage repository 108 may be a remote storage device. In one or more other cases, the data storage repository 108 may be a local storage device on the server 104. For example, the data storage repository 108 may be, but not limited to, a hard drive, non-volatile memory, or a USB stick.

In one or more cases, computing devices 110, 114, and 116 are clients to the server 104. The computing devices 110, 114, and 116 may be, for example, a desktop computer, a laptop computer, a tablet computer, a personal digital assistant (PDA), a smart phone, a thin client, a voice assistant device, a digital assistant, or any other electronic device or computing system capable of communicating with server 104 through network 102. For example, device 110 may be a desktop computer capable of connecting to the network 106 to access one or more components of the system 102, for example, to create or update features for a delivery location, to plan or update one or more routes, and to train or update one or more models, such as a door-step time (DST) model 216 described herein. In one or more cases, one or more of the devices 110, 114, and 116 may be any suitable type of mobile device capable of running mobile applications, including smart phones, tablets, slate, or any type of device that runs a mobile operating system. In an example, the device 114 may be a mobile device capable of connecting to the network 106 and receiving planned routes, such as planned route 228, and/or notifications, tips, and/or instructions on delivering a delivery order to a delivery location. Moreover, the device 114 may be capable of receiving an input from the delivery associate or the customer that indicates that the delivery associate delivered the order. For instance, the delivery associate may scan a barcode of a delivery order and/or a customer may input a signature onto the display and user interface of the device to indicate that the delivery associate delivered the delivery order. In another examples, the device 114 includes a camera, and the delivery associate use the device 114 to take photographs of the delivered order to show proof of delivery. Additionally, the delivery associate may take photographs of the delivery location, nearby parking, and other like features of a delivery location, such that the system 102 may associate these photographs with the delivery location and provide these photographs as aides to a delivery associate who delivers a subsequent order to this location. The system 102 may store the one or more photographs in the data storage repository 108. In some examples, the device 116 may be a customer's mobile device capable of connecting to the network 106 to place a delivery order on the e-commerce website, receive updates on the status of a delivery order, and/or notifications when a delivery order is nearby.

In one or more cases, one or more of the devices 110, 114, and 116 includes a user interface for providing an end user with the capability to interact with the system 102. For example, an end user of the computing device 110 may access the system 102 through the user interface to access one or more components of the system 102, for example, to create or update features for a delivery location, to plan or update one or more routes, and to train or update one or more models, such as the DST model 216 described herein. In another example, an end user of computing device 116 may receive delivery order updates from the system 102 through the user interface. A user interface refers to the information (such as graphic, text, and sound) a program presents to a user and the control sequences the user employs to control the program. The user interface can be a graphical user interface (GUI). A GUI may allow users to interact with electronic devices, such as a keyboard and mouse, through graphical icons and visual indicators, such as secondary notations, as opposed to text-based interfaces, typed command labels, or text navigation. For example, the GUI may allow users to view, access, and interact with an ecommerce website or mobile application hosted on the server 104, which allows users to purchase products and track an order status of the purchased goods.

In one or more cases, the location detector 112 may be a passive GPS recorder configured to track the location, speed, and corresponding time of the location detector 112. In one or more cases, the location detector 112 transmits the location, speed, and timestamp data to the system 102. In some cases, the location detector 112 may be an active GPS recorder configured to track and transmit the location, speed, and timestamp data to the system 102 in real-time. In other cases, the location detector 112 may store the location, speed, and timestamp data locally on the location detector 112, which may be uploaded to the system 102 via one of computing device 110 or 114. In some other cases, the location detector 112 may be a radio-frequency identification (RFID) location tracker configured to track the location, speed, and corresponding time of the location detector 112 in real-time. In some other cases, the location detector 112 may be a beacon tracker configured to track the location, speed, and corresponding time of the location detector 112 in real-time. In other cases, the location detector 112 may be a location provider application integrated with a computing device, such as computing device 114, and is configured to provide the geographical location of the computing device. In one or more cases, the location detector 112 may be an internet of things device configured to detect various signals, such as a delivery associate walking or entering an elevator. In one or more cases, having received locations from one or more location detectors and in addition to receiving other signals to aid in determining a location of a location detector, the system 102 may employ various methods to further determine positions of the respective location detector. For instance, the system 102 may employ triangulation based location detection methods, structure from motion methods, simultaneous localization and mapping (SLAM) methods, visual-inertial odometry (VIO) methods, and other like methods to further determine the location of a location detector. In one or more cases, the system 102 may set the location detector 112 to transmit the location data, speed data, and timestamp data at various time intervals, e.g., transmitting the data between two pings, in order to optimize the battery of the location detector 112, and save network cost and/or bandwidth. Additionally or alternatively to transmitting the data at various time intervals, the system 102 may set the location detector 112 to transmit the location data, speed data, and timestamp data based on speed. For example, for the cases in which the location detector 112 moves at a lower speed, the system 102 may set the location detector 112 to transmit the data at an increased time difference between two pings. In another example, for the cases in which the location detector 112 moves at a faster speed, the system 102 may set the location detector 112 to transmit the data at a decreased time difference between two pings. By varying the time intervals based on the speed of a moving location detector 112, the system 102 may provide similar spatial resolution of the pings.

In one or more cases, the location detector 112 can be a stand-alone device that is attached to a delivery associate, a delivery vehicle, one or more totes of a delivery order, and other like objects that indicate the movement of a delivery order. The location detector 112 may be configured to provide GPS coordinates and corresponding timestamps to the system 102 for the object (e.g., a delivery associate, delivery vehicle, tote, and the like) attached to the location detector 112. It is noted that one location detector 112 is described, but it should be understood that multiple location detectors may be used. For instance, a delivery associate and delivery vehicle may each have a location detector 112 in order for the system 102 to determine the location of the delivery vehicle and to determine the location of the delivery associate after leaving the delivery vehicle to deliver the order to a customer's location. In one or more other cases, the location detector 112 may be integrated with the computing device 114 operated by the delivery associate. For instance, for the cases in which the computing device 114 is a smartphone or wearable device, such as a smartwatch, the location detector 112 may utilize the GPS, accelerometer, gyroscope, pedometer, and other services or application programming interfaces that track motion of the smartphone to provide location data, speed data, and timestamp data of the computing device 114, which corresponds to the location of the delivery associate. In another instance, the computing device 114 may be a handheld scanning device that is configured to electronically capture delivery order information, such as barcodes, or capture signatures from the delivery associate and/or customer. In such cases, the location detector 112 may be integrated with the scanning device, such that the delivery associate utilizes one device to scan a barcode positioned on one or more totes corresponding to the delivery order, or a receipt corresponding to the delivery order, and provide location data, speed data, and timestamp data to the system 102. Moreover, it is noted that for the cases in which multiple location detectors are employed, the location detectors may employ the same technology (e.g., all of the location detectors may be active GPS recorders) or may employ a variety of technology based on the tracking needs of the object (e.g., an active GPS recording location detector may be attach to a delivery vehicle, and a location provider application may be integrated with the delivery associate's computing device 114).

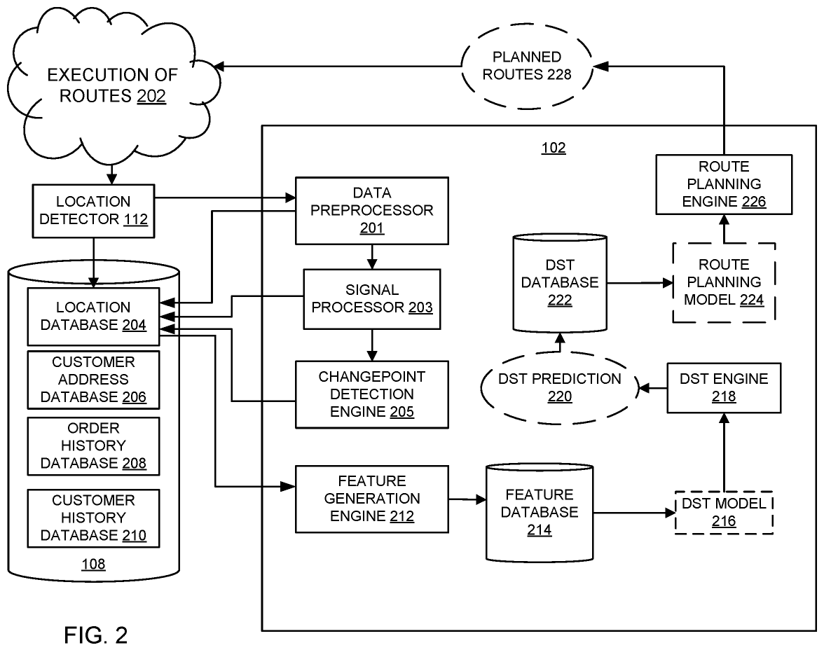

FIG. 2 is a functional block diagram illustrating components of the data processing environment 100 of FIG. 1.

In one or more cases, the data storage repository 108 includes one or more databases for storing information. For example, the data storage repository 108 may include a location database 204, a customer address database 206, an order history database 208, and a customer history database 210. In one or more cases, the location database 204 may store geographical data, such as GPS coordinates, of one or more location detectors 112 as well as the timestamps when the location detector 112 recorded the geographical data. In one or more cases, the location detector 112 may automatically push the geographical data and corresponding timestamps to the location database 204 in real-time, via network 106. In one or more other cases, a location detector 112 may collect and store the geographical data and timestamps locally, and a computing device, such as computing devices 110 and 114 may upload the geographical data and timestamps to the location database 204. In one or more cases, the customer address database 206 may store data corresponding to an address that a customer receives a delivery order. In one or more cases, the order history database 208 may store data corresponding to a date when a customer placed an order and a delivery window, which includes for example a date and time range when the customer requested to receive the order. In one or more cases, the customer history database 210 may store data corresponding to descriptive information of the good, for example but not limited to, a type of the good, a title of the good, a brand of the good, descriptive phrases of the good, a size of the good, and the like and corresponding to a number of each type of good ordered by the customer in the delivery order. In another example, the customer history database 210 may store the number of totes occupied by the one or more goods in a customer's delivery order. In another example, the customer history database 210 may store the weight and/or volume of the goods and/or totes of the customer's delivery order. It is noted that the databases may store information for more than one customer. It is also noted that the information stored within these databases may be tagged with an identifier, as described herein, that correlates each piece of data across the multiple databases. For example, information related to a first customer may be tagged with a first identifier such that the information stored in the databases corresponds to the first customer. In one or more other cases, the data storage repository 108 may also include a geographic information systems (GIS) database configured to store various extensions, for example, but not limited to, map network features (e.g. a street intersection one half of a mile into the route) obtained using an open source routing machine (OSRM) or the like. In some cases, the GIS database is included in the location database 204. In other cases, the GIS database is separate database included in the data storage repository.

It is noted that FIG. 2 illustrates the location database 204, the customer address database 206, the order history database 208, and the customer history database 210 as individual databases localized on the data storage repository 108, and the feature database 214 and the DST database 222 localized on the system 102 and server 104. However, it should be understood that each of these databases may be localized on the data storage repository 108, on the server 104, or distributed on other data storage repositories and servers. Moreover, it should be understood that the data stored within these databases may be stored collectively on one database, or on more than one database, in which either case the data may be stored locally or remotely from the data storage repository 108.

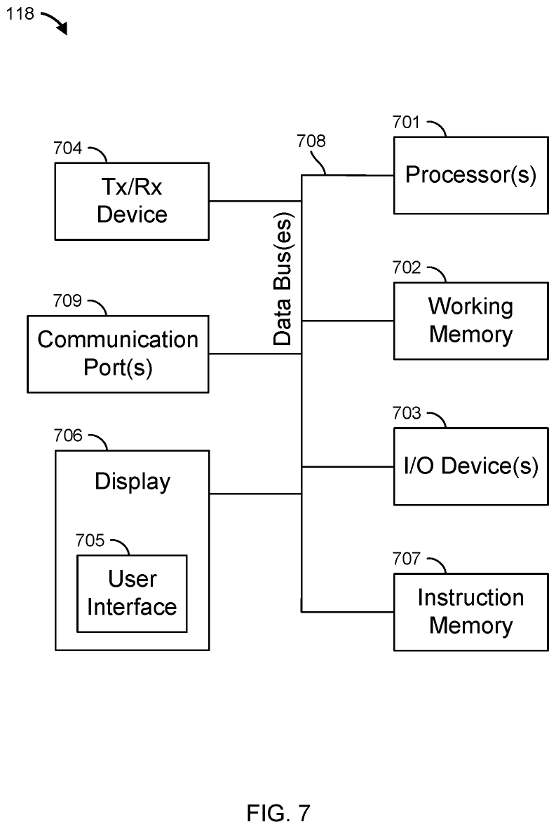

In one or more cases, the system 102 includes a changepoint detection engine 205, a feature generation engine 212, a door-step time (DST) engine 218, and a route planning engine 226. In one or more examples, one or more of the changepoint detection engine 205, the feature generation engine 212, the DST engine 218, and the route planning engine 226 may be implemented in hardware. In one or more examples, one or more of the changepoint detection engine 205, the feature generation engine 212, the DST engine 218, and the route planning engine 226 may be implemented as an executable program maintained in a tangible, non-transitory memory, such as instruction memory 707 of FIG. 7, which may be executed by one or processors, such as processor 701 of FIG. 7.

In one or more cases, the system 102 includes a data preprocessor 201, the features of which may be implemented in hardware and/or software. The data preprocessor 201 may be configured to receive raw signals and to process the raw signals to remove invalid data, anomalies, and the like. For example, the data preprocessor 201 may be configured to receive raw signals representing location data collected by the location detector 112, and process the raw location signals to remove latitude and longitude coordinates indicating 0, duplicates of latitude and longitude coordinates, highly erroneous measurements due to instrument faults of the location detector 112, and other like invalid data or anomalies. In one or more cases, the data preprocessor 201 may process the raw signals in an online mode, i.e. processing the raw signals as the signals are received from the location detector 112, using one or more data buffers. In one or more other cases, the data preprocessor 201 may process the raw signals in an offline mode, i.e., processing raw signals retrieved from a data storage repository, such as the data storage repository 108, and in particular the location database 204. For the cases in which the server 104 utilizes a distributed computing system, the data preprocessor 201 utilizes the distributed computing components of the server 104 to process the raw signals in parallel.

In one or more cases, the system 102 includes a signal processor 203, the features of which may be implemented in hardware and/or software. In one or more cases, the signal processor 203 is configured to receive the processed signals from the data preprocessor 201. The signal processor 203 further processes the received processed signals using a variety of methods, such as Fourier Transform methods, Wavelet Transform methods, Spectral methods, and the like. Moreover, the signal processor 203 may employ noise removal algorithms to the signals and further clean the signals for generating features and/or building models. In one or more cases, the signal processor 203 may be implemented in hardware that processes signals, for example, but not limited to, sound cards. It should be noted that, although the data preprocessor 201 and the signal processor 203 are illustrated as separate components, the features of the data preprocessor 201 and signal processor 203 may be executed on the same processor, such as processor 701 of FIG. 7, or more than one processor.

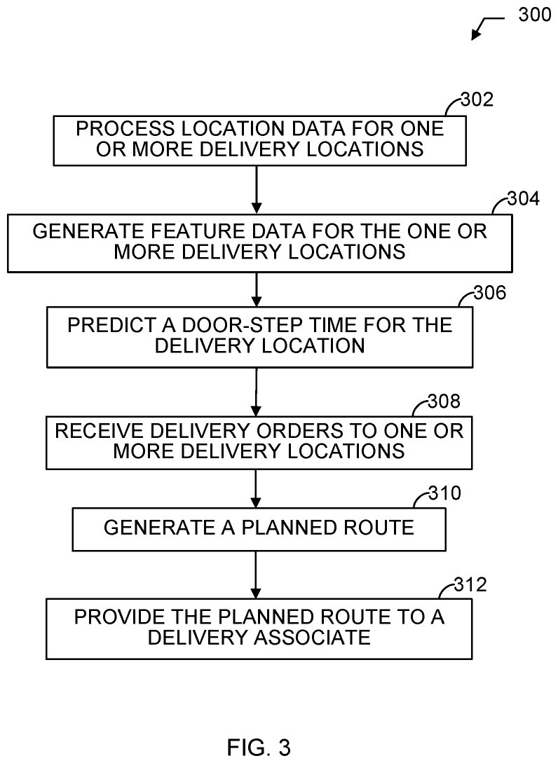

FIG. 3 is a flowchart illustrating a process 300 of delivery route optimization.

It is noted that, while the examples discussed herein are directed predicting door-step times for one or more delivery locations and to optimizing routes for grocery delivery orders for customers based on the predicted door-step times, the embodiments discussed herein may be used to optimize routes for the transportation of any type of goods between business entities and/or customers based on the predicted door-step times, and are not limited to optimizing routes for grocery deliveries. Moreover, the embodiments discussed herein may be directed to transporting goods between various types of business entities, such as between a supplier and a manufacturer, a manufacturer and a distributor, a distributor and a retailer, a retailer and a shopper, or any combination of thereof.

Location data for one or more delivery locations is processed (302), preferably by the system 102. In one or more cases, in a training environment, the system 102 receives raw location signal data from the location detector 112 for processing. For example, as a delivery associate delivers orders to customers, one or more location detectors, such as location detector 112, records the location, such as the longitude and latitude coordinates, of the corresponding location detector 112 and the timestamp that the location detector 112 records the location. In another example, the one or more location detectors may record the location, corresponding timestamp, and the speed in which the location detector 112 moves. In one or more cases, the system 102 may retrieve previously stored raw location data from the location database 204 for processing. In one or more cases, one or more location detectors may be attached to the delivery vehicle to record location data of the delivery vehicle, to one or more totes within the delivery vehicle to record the location data of the respective tote, to the delivery associate, to the computing device 114, and any combination thereof. A tote may be a reusable container, bag, or the like, which the delivery associate uses to transport the delivery order from the delivery associate's vehicle to the customer's delivery location. It is noted that to generate feature data for a delivery location, the system 101 may generate feature data as described herein using previously collected location data from past orders. Having created feature data for a delivery location, the system 102 is configured to update the feature data using location data collected and processed in future delivery orders.

In one or more cases, the system 102 and/or the data repository 108 may be configured to compile the raw location signal data for the one or more objects tracked by one or more location detectors 112 in a respective delivery order. Moreover, the system 102 and/or data repository 108 generates an identifier for the compiled location data and stores the identifier and the corresponding location data in the location database 204. In one or more cases, when the delivery associate delivers the delivery order to the delivery location, the delivery associate may, for example, use the computing device 114 to scan the barcode corresponding to the delivery order to indicate that the order was delivered. In other examples, the delivery associate may take a picture with the computing device 114 of the delivered order, or may have the customer input a signature into the computing device 114 to indicate that the delivery associate delivered the order. The computing device 114 may record the timestamp when the order was delivered, and transmit the record timestamp to the system 102. The system 102 associates the identifier of the compiled location data with the recorded delivery timestamp, and stores the recorded delivery timestamp with the location data and identifier in the location database 204. In one or more cases, the delivery vehicle includes a sensor configured to determine and record timestamps when the ignition of the delivery vehicle is turned on and turned off. Having detected when the delivery vehicle is turned on and/or turned off, the sensor may transmit the recorded timestamp to the system 102. The system 102 associates the recorded timestamps from the sensor of the delivery vehicle to the identifier of the compiled location data and the recorded delivery timestamp.

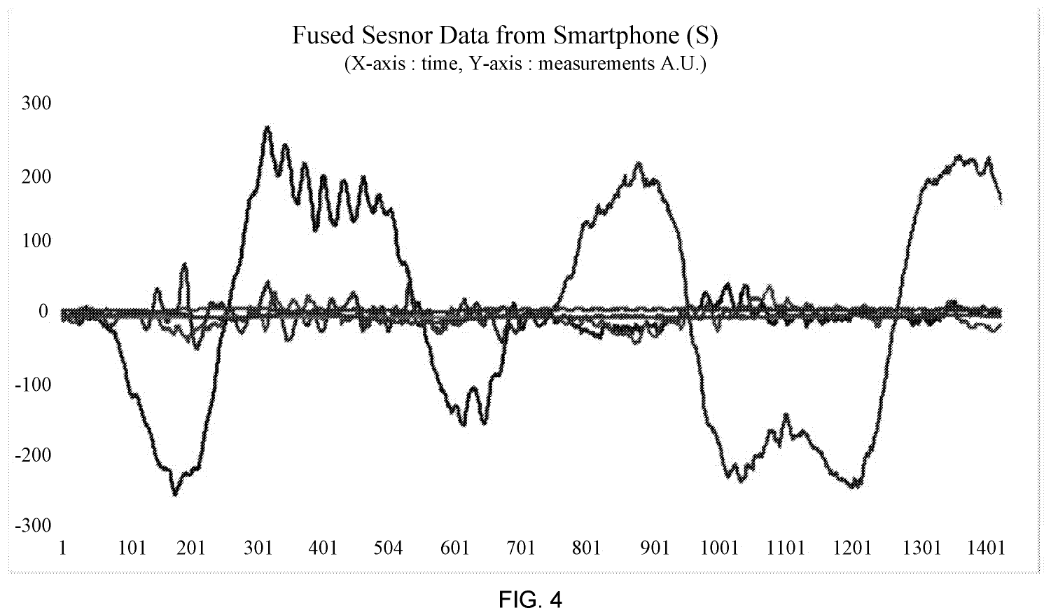

It is noted that the system 102 may generate identifiers for one or more delivery orders and stores the identifiers and corresponding compiled location data, recorded delivery timestamp, and timestamps generated by the ignition sensor in the location database 204. FIG. 4 illustrates example raw signals of a past delivery order, which includes compiled raw location signal data, signals indicating when the delivery order was delivered, and signals indicating when the ignition of the delivery vehicle was turned on and turned off.

In one or more cases, the system 102 provides the raw signal data to the data preprocessor 201. The data preprocessor 201 may process the received raw signal data, illustrated in FIG. 4 for example, to remove invalid data, anomalies, and the like, as discussed herein. Having processed the raw signal data, the data preprocessor 201 provides the processed raw signal data to the signal processor 203. The signal processor 203 further processes the received processed signals using a variety of methods, such as Fourier Transform methods, Wavelet Transform methods, Spectral methods, and the like. Moreover, the signal processor 203 may employ noise removal algorithms to the signals and further clean the signals to generate features and/or build models. The signal processor 203 stores the output of the additionally processed data in the location database 204, and provides the output to the changepoint detection engine 205.

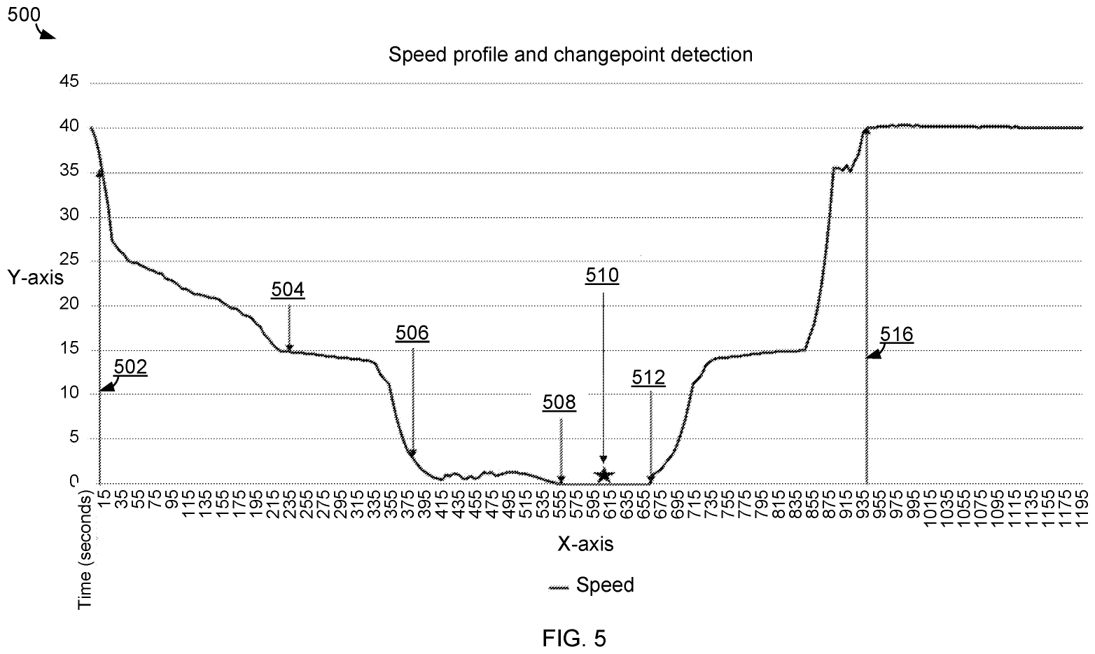

In one or more cases, the changepoint detection engine 205 is configured to apply a changepoint detection algorithm on the received output to generate a speed profile for a delivery order. For instance, the changepoint detection engine 205 may apply one or more of Bayesian graphical models, Bayesian Networks, Probabilistic graphical models, Hidden Markov Models, recurrent neural networks, and the like to generate a speed profile, such as the example speed profile 500 illustrated in FIG. 5, for a delivery order. Moreover, the changepoint detection engine 205 may apply one or more of the Bayesian graphical models, Bayesian Networks, Probabilistic graphical models, Hidden Markov Models, recurrent neural networks, and the like to generate an acceleration profile, a jerk profile and other like profiles. The example speed profile 500 may be representative of a delivery between one delivery location to the location of the delivery order. The y-axis of the example speed profile graph 500 may represent speed of the location detectors, and the x-axis may represent the time of the corresponding recorded speed. The speed profile graph 500 may indicate changes in the sequence of location data corresponding to the delivery order. For example, the speed profile graph 500 may indicate when during the delivery route the delivery vehicle decreased speed to exit the freeway 502, further decreased speed when entering the locality of the delivery location 504, further decreased speed to look for parking 506, parked the delivery vehicle 508, scanned the barcode of the delivery order (i.e., indicating the order was delivered), started the delivery vehicle 512, and increased speed to enter the freeway 514. In one or more cases, the changepoint detection engine 205 may store the speed profile with the identifier corresponding to the delivery location in the location database 204.

In one or more cases, the changepoint detection engine 205 may plot recorded location data, for example location 602, provided by one or more location detectors 112 on a map. The series of plotted location data 600 may be representative of the route a delivery associate took from one delivery location 604 to the delivery location 606 in the example speed profile graph 500. The changepoint detection engine 205 may also provide a key 608 indicating the number of recorded location data that corresponds to a certain motion by the delivery associate. For example, the changepoint detection engine 205 determined that there were 98 recorded location data plots that indicate the delivery associate was driving, and that there were 8 recorded location data plots that indicate the delivery associate was still.

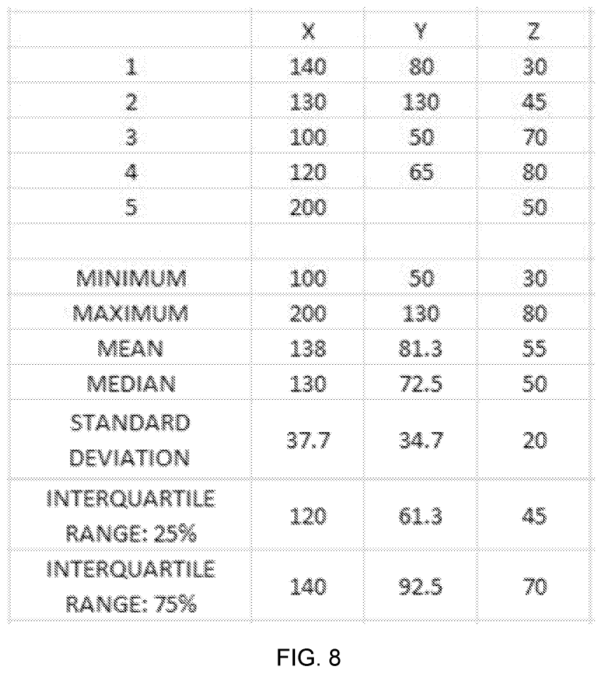

Feature data for one or more delivery locations is generated (304), preferably by the feature generation engine 212. The feature data provides a profile for a respective delivery location. In one or more cases, the feature generation engine 212 generates feature data of a delivery location by compiling data corresponding to the delivery location from the data storage repository 108. For example, the feature generation engine 212 may retrieve location data, a speed profile, and an identifier for a first delivery location. Based on the identifier of the first delivery location, the feature generation engine 212 may retrieve corresponding data from the customer address database 206, the order history database 208, and the customer history database 210. The feature generation engine 212 may compile the retrieved data into feature data for the first delivery location. For example, the feature generation engine 212 may generate feature data for the first delivery location that includes the first customer's address, which is retrieved from the customer address database 206; the dates and delivery windows the first customer previously placed a delivery order, which is retrieved from the order history database 208; and the descriptive information on goods and number of totes to carry the goods for one or more past delivery orders retrieved from the customer history database 210. In one or more cases, the feature generation engine 212 determines the minimum, maximum, standard deviation, an interquartile range, and other like measurements for the generated feature data. Referring to FIG. 8, for example, the X locations (e.g., X1, X2, X3, X4, and X5) may correspond to locations in busy and crowded cities, the Y locations (e.g., Y1, Y2, Y3, and Y4) may correspond to locations in suburban areas, and the Z locations (e.g., Z1, Z2, Z3, Z4, and Z5) may correspond to locations in rural areas. The raw DST for a location, e.g., X1 may be, for example, 140 seconds, Y1 may have a raw DST of 80 seconds, and Z1 may have raw DST of 30 seconds. FIG. 8 illustrates example minimum DSTs, maximum DSTs, mean DST values, median DST values, standard deviations, and an interquartile range from 25% to 75% for the example locations.

Moreover, the feature data may include descriptive information about the delivery location that is discerned from the speed profile or noted by delivery associates when delivering orders to the delivery location. For instance, the feature data may include, for example but not limited to, information indicating the type of dwelling (e.g., single family home, multi-family home, apartment complex, business at a commercial property, etc.), that parking is limited around the delivery location, and that the delivery location is located on a floor that can only be accessed via a staircase. For example, the feature data may indicate that the delivery location of the first customer may be a single family home with ample parking. In another example, the feature data of the delivery location of the second customer may indicate that the delivery location is a multi-family home and that delivery requires ascending two sets of staircases. In another example, the feature data of the delivery location of the third customer may indicate that the delivery location is on the 10^{th} floor of an apartment complex with elevator access but limited parking. In yet another example, the feature data may include weather forecasts for the delivery location. In cases in which the weather (e.g., snow, rain, etc.) makes delivering orders difficult or causes delays, the system 102 may adjust the DST prediction for the location based on the weather forecast.

In one or more cases, the feature generation engine 212 generates feature data at different level views. For example, the feature generation engine 212 may generate feature data for an individual customer at a delivery location. In another example, the feature generation engine 212 may generate feature data for a delivery location, which may include one or more customers. In other examples, the feature generation engine 212 may generate feature data for delivery locations within a locality or a neighborhood. In yet other examples in which the system 102 does not have past order histories or DSTs for a customer at a particular delivery location, the feature generation engine 212 may generate feature data for delivery locations based on features of the store from which the delivery associate retrieves the delivery order. The features of the store may include, for example, but not limited to, a location of the store and the degree of difficulty of parking the delivery vehicle, an average time to load the delivery order into the delivery vehicle, and other like features. In one or more cases, the feature generation engine 212 may generate feature data for a delivery location based on a time period, including but not limited to, a time of day, a day of the week, a delivery window, and the like. In one or more cases, the feature generation engine 212 may generate feature data based on the dwelling type of the delivery location, for example, but not limited to, gated or non-gated apartments, a floor of an apartment, a single family home, a business at a commercial property. It is noted that feature data may not be limited to the example level views described herein, and may also be based on any combination of the aforementioned. For example, the feature data may be generated based on the individual customer at the delivery location and a delivery window on a particular day of the week.

In one or more cases, the feature generation engine 212 may apply a feature synthesis algorithm to the retrieved data to automatically generate feature data for the delivery location. In one or more other cases, the feature generation engine 212 may receive input from an operator of the system 102 in order to manually generate features for a delivery location. For example, the operator may implement techniques such as spatial indexing, geo-hashing, and the like to create quick look-up tables of longitude and latitude coordinates that correspond to localities or neighborhoods that have customers that receive delivery orders.

The feature generation engine 212 may store the feature data for the delivery location in the feature database 214. The feature generation engine 212 generates feature data for one or more other delivery locations in the location database 204 and stores the feature data for these delivery locations in the feature database 214. For instance, the feature generation engine 212 may generate feature data for the delivery location corresponding to a second customer and the delivery location corresponding to a third customer.

A door-step time (DST) for a delivery location is predicted (306), preferably by the DST engine 218. To predict a DST for the delivery location, the DST engine 218 applies a DST model 216 to the feature data of the delivery location, which outputs a DST prediction 220. In one or more cases, the DST engine 218 determines DST prediction 220 based on a time difference between two events in the delivery of an order. In an example, a time difference between two events may include the time when the delivery associate turns off the ignition to the delivery vehicle and the time when the delivery associate returns to the delivery vehicle and turns on the ignition. In another example, the time difference between two events may include the time when the delivery associate removes the first tote of the delivery order from the delivery vehicle and the time when the delivery associate returns to the delivery vehicle after having delivered all of the totes of the delivery order. In yet another example, the DST engine 218 determines DST prediction 220 based on the time interval that includes a delivery associate locating a parking spot, parking the delivery vehicle, bringing the delivery order from the delivery vehicle to the customer's door-step, returning to the delivery vehicle, and driving the delivery vehicle away from the parking spot.

In one or more cases, the DST model 216 is a machine learning model configured to use an ensemble learning algorithms or other algorithms, such as but not limited to, k-nearest neighbors algorithms, linear regression algorithms, neural networks, and the like, to predict the DST. The DST model 216 may predict a DST for a delivery location, based on order size, time of day, or other feature data discussed herein. The ensemble learning algorithms may include, for example but not limited to, gradient boosting algorithms, random forest algorithms, and the like. In one or more cases, the DST model 216 outputs the DST prediction 220 as a singular value, i.e., a point estimate. In one or more other cases, the DST model 216 outputs the DST prediction 220 as a range of predictions, such that the DST prediction 220 is a mean value with a prediction interval (e.g., a mean value of 10 seconds with a prediction interval of +/−2 seconds). The DST engine 218 determines the prediction interval based on the empirical ensemble of DST predictions 220 for the delivery location or from distributional assumptions on the DST predictions 220 for the delivery location. The DST engine 218 may determine the DST predictions 220 for the delivery locations stored within the feature database 214, and may store the DST predictions 220 along with the corresponding identifier in the DST database 222. For example, the DST engine 218 may determine that the DST prediction 220 for the delivery location of the first customer may be 30 seconds+/−10 seconds. In another example, the DST engine 218 may determine that the DST prediction for the delivery location of the second customer may be, for example, 3 minutes+/−30 seconds. In another example, the DST engine 218 may determine that the DST prediction for the delivery location of the third customer may be, for example, 15 minutes+/−5 minutes.

The embodiments discussed herein improve upon transportation logistics by optimizing delivery routes, for instance last mile deliveries, based on DST predictions that account for variables that effect a door-step time for deliveries to a respective delivery location. By accounting for the locations of the delivery orders as well as the respective variables that effect door-step time at the respective delivery locations, via the DST predictions, when the system 102 receives one or more delivery orders, the system 102 may generate optimized delivery routes by allocating certain delivery orders to certain delivery vehicles. As such, the optimized delivery routes allow the delivery associate to avoid missing delivery windows, reduce the distance of the delivery route, and reduce the driving time required to complete the delivery route.

Delivery orders to one or more locations are received (308), preferably by the system 102. In one or more cases, in a live environment, the system 102 receives the delivery orders to the one or more locations from customers who input their orders on the e-commerce. For example, the system 102 may receive a first order from the first customer that includes two totes worth of groceries delivered to the first customer's address, i.e., the first delivery location, between 1 p.m. and 3 p.m. on Friday, April 24th. The system 102 may also receive, for example, a second order from a second customer that includes two totes worth of groceries delivered to the second customer's address, i.e., the second delivery location, between 1:30 p.m. and 3:30 p.m. on Friday, April 24th. The system 102 may also receive, for example, a third order from a third customer that includes three totes worth of groceries delivered to the third customer's address, i.e., the third delivery location, between 2 p.m. and 3 p.m. on Friday, April 24th. To place the order, the user may select a delivery window and a delivery location to receive the order. The delivery window may include, for example, a date and a specific time or time range to receive the order at the location.

Having received the delivery orders, a planned route is generated (310), preferably by the route planning engine 226. In one or more cases, the system 102, and preferably the route planning engine 226, determines the delivery location of a received delivery order, based on the address provided by the customer in the delivery order or based on the longitude and latitude coordinates of the address. The route planning engine 226 may retrieve the identifier of the customer's address from either the customer address database 206 or the location database 204. Having retrieved the identifier, the route planning engine 226 retrieves one or more DST predictions 220, which correspond to the retrieved identifier, from the DST database 222. For example, the DST prediction 220 for the delivery location of the first customer may be 30 seconds+/−10 seconds. The DST prediction 220 for the delivery location of the second customer may be, for example, 3 minutes+/−30 seconds. The DST prediction 220 for the delivery location of the third customer may be, for example, 15 minutes+/−5 minutes.

Based on the distance between each customers' address, current number of totes necessary for transporting each received delivery order, DST prediction 220 for each delivery location, and the requested delivery window for the received delivery orders, the route planning engine 226 may determine that more than one delivery vehicle is needed to deliver the first order, second order, and third order within the requested delivery window from the transportation facility, for example, a warehouse or store where the goods are stored, to the respective delivery locations of the first order, second order, and third order. In an example, to deliver the orders within the requested time windows, the route planning engine 226 generates planned routes 228 for two delivery vehicles, in which one vehicle transports the first and second order and another vehicle transports the third order. In another example, the route planning engine 226 generates the planned routes 228 for three delivery vehicles, in which each vehicle transports an order. In one or more cases, the planned route 228 may include directions to the delivery locations of the delivery orders; the order in which the delivery associate delivers the delivery orders and requested delivery window of the respective delivery orders; and the tote or totes corresponding to the respective delivery order.

The planned route 228 is provided to a delivery associate (312), preferably by the route planning engine 226. In one or more cases, the route planning engine 226 provides the planned route 228 to the delivery associate by either uploading the planned route 228 to the delivery associate's computing device 114, to a navigation system within the delivery vehicle, or to the delivery associate's smartphone. In one or more other cases, the delivery associate may receive the planned route 228 on a manifest, which may be displayed on a user interface of the computing device 114 or provided on paper, white board, or the like.

In one or more cases, as the delivery associate is delivering the orders, one or more location detectors 112 may provide location data to the system 102 in real-time. The system 102 may compare the received location data and compare the location data to the delivery order locations and requested delivery windows in the planned route 228. In one or more cases, by comparing the received location data to information within the planned route 228, the system 102 may determine whether one or more of the delivery orders of the planned route 228 will not be delivered within the corresponding delivery window. In some case, when the system 102 determines that a delivery order will not be delivered within the corresponding window, the system 102 may transmit a notification, for example a text message or email, to the customer indicating that the delivery order is delayed.

In one or more cases, by comparing the received location data to information within the planned route 228, the system 102 may determine when a delivery vehicle enters a predetermined geo-fence of the delivery location, and transmits a notification, for example a text message or email, to the customer indicating that the delivery associate is near the delivery location and/or an estimated time of arrival for the delivery order. Moreover, in addition to sending a notification to the customer in response to the delivery associate entering the geo-fence, the system 102 may use the DST prediction and/or speed profile for the delivery location to determine the average time the delivery associate takes to deliver one or more totes in a comparable delivery order at the delivery location. Based on the location data received in real-time and the average time to deliver a comparable delivery order to the current delivery order, the system 102 may detect when for example, the delivery vehicle is slowing down to enter the locality of the delivery location or when the ignition of the delivery vehicle is turned off, and transmit a notification to the customer with an estimated time of arrival the corresponds to the determined average time. As such, the customer receives a more accurate estimated time of arrival, which allows the customer to prepare for the delivery associates arrival, thereby leading to faster delivery and allowing the delivery associate to return to the delivery vehicle more quickly.

In yet one or more other cases, by comparing the received location data to information within the planned route 228, the system 102 may determine when a delivery vehicle enters a predetermined geo-fence of the delivery location, and transmits a notification, for example a text message or voice message, to the delivery associate to provide one or more details about the delivery location, for example, but not limited to, where to park the delivery vehicle, where the entrance of the delivery location is located, whether or not the delivery location has elevator access, and other like notifications. By providing these notifications, the delivery associate, in particular one who is not familiar with the locality of the delivery location, may understand, for instance, where to easily park the delivery vehicle and efficiently deliver the order to the delivery location. In some examples, the system 102 may associate the delivery location with one or more photographs taken of the delivery location in a previous delivery. The system 102 may load the one or more photographs from the data storage repository 108 and include in the notification one or more photographs of the delivery location, nearby parking, or other like features of the delivery location. The delivery associate may use the photographs to easily find the delivery location, nearby parking, and understand other features of the delivery location.

In yet one or more cases, the system 102 may provide the received location data to the one or more components of the system 102, for example, the changepoint detection engine 205, the feature generation engine 212 and/or the DST engine 218 to update the speed profiles, feature data, and DST predictions of the corresponding delivery locations.

FIG. 7 depicts a block diagram of components of a computing device capable of performing the processes described herein. In particular, FIG. 7 illustrates an example computing device, such as computing device 118, capable of interacting with the system 102 of FIG. 1.

Computing device 118 can include one or more processors 701, working memory 702, one or more input/output devices 703, instruction memory 707, a transceiver 704, one or more communication ports 709, and a display 706, all operatively coupled to one or more data buses 708. Data buses 708 allow for communication among the various devices. Data buses 708 can include wired, or wireless, communication channels.

Processors 701 can include one or more distinct processors, each having one or more cores. Each of the distinct processors can have the same or different structure. Processors 701 can include one or more central processing units (CPUs), one or more graphics processing units (GPUs), application specific integrated circuits (ASICs), digital signal processors (DSPs), and the like.

Processors 701 can be configured to perform a certain function or operation by executing code, stored on instruction memory 707, embodying the function or operation. For example, processors 701 can be configured to perform one or more of any function, method, or operation disclosed herein.

Instruction memory 707 can store instructions that can be accessed (e.g., read) and executed by processors 701. For example, instruction memory 707 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 701 can store data to, and read data from, working memory 702. For example, processors 701 can store a working set of instructions to working memory 702, such as instructions loaded from instruction memory 707. Processors 701 can also use working memory 702 to store data created during the operation of system 102. Working memory 702 can be a random access memory (RAM) such as a static random access memory (SRAM) or dynamic random access memory (DRAM), or any other suitable memory.

Input-output devices 703 can include any suitable device that allows for data input or output. For example, input-output devices 703 can include one or more of a keyboard, a touchpad, a mouse, a stylus, a touchscreen, a physical button, a speaker, a microphone, or any other suitable input or output device.

Communication port(s) 709 can include, for example, a serial port such as a universal asynchronous receiver/transmitter (UART) connection, a Universal Serial Bus (USB) connection, or any other suitable communication port or connection. In some examples, communication port(s) 709 allows for the programming of executable instructions in instruction memory 707. In some examples, communication port(s) 709 allow for the transfer (e.g., uploading or downloading) of data, such as transaction data.

Display 706 can display user interface 705. User interfaces 705 can enable user interaction with, for example, computing device 112 or 118. For example, user interface 705 can be a user interface for an application of a retailer that allows a customer to purchase one or more items from the retailer. In some examples, a user can interact with user interface 705 by engaging input-output devices 703. In some examples, display 706 can be a touchscreen, in which the touchscreen displays the user interface 705.

Transceiver 704 allows for communication with a network, such as the network 106 of FIG. 1. For example, if network 106 of FIG. 1 is a cellular network, transceiver 704 is configured to allow communications with the cellular network. In some examples, transceiver 704 is selected based on the type of network 106 system 102 will be operating in. Processor(s) 701 is operable to receive data from, or send data to, a network, such as network 106 of FIG. 1, via transceiver 704.

Although the embodiments discussed herein are described with reference to the figures, it will be appreciated that many other ways of performing the acts associated with the embodiments can be used. For example, the order of some operations may be changed, and some of the operations described may be optional.

In addition, the embodiments described herein can be at least partially implemented in the form of computer-implemented processes and apparatus. The disclosed embodiments may also be at least partially implemented in the form of tangible, non-transitory machine-readable storage media encoded with computer program code. For example, the processes described herein can be implemented in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the embodiments. The embodiments may also be at least partially implemented in the form of a computer into which computer program code is loaded or executed, such that, the computer becomes a special purpose computer for practicing the embodiments. When implemented on a general-purpose processor, the computer program code segments configure the processor to create specific logic circuits. The embodiments may alternatively be at least partially implemented in application specific integrated circuits for performing the embodiments.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. A system comprising a memory having instructions stored thereon, and a processor configured to read the instructions to:
generate a speed profile for one or more delivery locations, the speed profile corresponding to location data of a delivery order for a respective delivery location, and the speed profile indicating a plurality of events associated with a movement of a delivery order to the respective delivery location;
generate, based on the speed profile and location data corresponding to the delivery order, feature data of the respective delivery location;
apply a machine learning model to the generated feature data to output a door-step time prediction for the respective delivery location, the door-step time prediction being based on a time difference between timestamps of two events of the plurality of events associated with the movement of the delivery order; and
generate a planned delivery route for the one or more delivery locations, based on the one or more delivery locations and the respective door-step time predictions.

2. The system of claim 1, further comprising:
a plurality of location detectors attached to an object associated with the delivery order, and configured to record the location data of the attached object; and
wherein the processor is further configured to read the instructions to:
receive the location data from the plurality of location detectors;
associate the location data from the plurality of location detectors to the delivery order; and
process the associated location data to remove invalid location data.

3. The system of claim 1, wherein the processor is further configured to generate the speed profile by applying a changepoint detection algorithm to the location data of the delivery order.

4. The system of claim 1, wherein the processor is further configured to generate the feature data by:
retrieving a history of a customer associated with the respective delivery location, wherein the history indicates one or more dates and delivery windows of delivery orders placed by the customer, and indicates information of one or more goods included in the delivery orders; and
generating the feature data based on the speed profile, location data, and history of the customer.

5. The system of claim 1, wherein the processor is further configured to generate the feature data based on at least one of a dwelling-type of the delivery location and a time period the delivered order was delivered.

6. The system of claim 1, wherein the timestamps of the two events comprise a timestamp associated with a time when an ignition of a delivery vehicle transporting the delivery order in an off-state and a timestamp associated with a time when the ignition of the delivery vehicle is in an on-state.

7. The system of claim 1, wherein the door-step time prediction of the delivery location comprises a range of door-step time predictions having a mean value and prediction interval.

8. The system of claim 1, wherein the processor is further configured to:
receive delivery orders to the one or more delivery locations, and
generate the planned delivery route by allocating the received delivery orders to one or more delivery vehicles based on the one or more delivery locations, requested deliver windows to receive the delivery order, and the door-step time predictions corresponding to the one or more delivery locations.

9. A method comprising:
generating a speed profile for one or more delivery locations, the speed profile corresponding to location data of a delivery order for a respective delivery location, and the speed profile indicating a plurality of events associated with a movement of a delivery order to the respective delivery location;
generating, based on the speed profile and location data corresponding to the delivery order, feature data of the respective delivery location;
applying a machine learning model to the generated feature data to output a door-step time prediction for the respective delivery location, the door-step time prediction being based on a time difference between timestamps of two events of the plurality of events associated with the movement of the delivery order; and
generating a planned delivery route for the one or more delivery locations, based on the one or more delivery locations and the respective door-step time predictions.

10. The method of claim 9, further comprising:
receiving the location data from a plurality of location detectors attached to an object associated with the delivery order;
associating the location data from the plurality of location detectors to the delivery order; and
processing the associated location data to remove invalid location data.

11. The method of claim 9, wherein the generating the speed profile further comprises applying a changepoint detection algorithm to the location data of the delivery order.

12. The method of claim 9, wherein the generating the feature data further comprises:
retrieving a history of a customer associated with the respective delivery location, wherein the history indicates one or more dates and delivery windows of delivery orders placed by the customer, and indicates information of one or more goods included in the delivery orders; and
generating the feature data based on the speed profile, location data, and history of the customer.

13. The method of claim 9, wherein the generating the feature data further comprises generating feature data based on at least one of a dwelling-type of the delivery location and a time period the delivered order was delivered.

14. The method of claim 9, wherein the timestamps of the two events comprise a timestamp associated with a time when an ignition of a delivery vehicle transporting the delivery order in an off-state and a timestamp associated with a time when the ignition of the delivery vehicle is in an on-state.

15. The method of claim 9, wherein the door-step time prediction of the delivery location comprises a range of door-step time predictions having a mean value and prediction interval.

16. The method of claim 9, further comprising receiving delivery orders to the one or more delivery locations,
wherein generating the planned delivery route further comprises allocating the received delivery orders to one or more delivery vehicles based on the one or more delivery locations, requested deliver windows to receive the delivery order, and the door-step time predictions corresponding to the one or more delivery locations.

17. A computer program product comprising:
a non-transitory computer readable medium having program instructions stored thereon, the program instructions executable by one or more processors, the program instructions comprising:
generating a speed profile for one or more delivery locations, the speed profile corresponding to location data of a delivery order for a respective delivery location, and the speed profile indicating a plurality of events associated with a movement of a delivery order to the respective delivery location;
generating, based on the speed profile and location data corresponding to the delivery order, feature data of the respective delivery location;
applying a machine learning model to the generated feature data to output a door-step time prediction for the respective delivery location, the door-step time prediction being based on a time difference between timestamps of two events of the plurality of events associated with the movement of the delivery order; and
generating a planned delivery route for the one or more delivery locations, based on the one or more delivery locations and the respective door-step time predictions.

18. The computer program product of claim 17, wherein the generating the feature data further comprises:
retrieving a history of a customer associated with the respective delivery location, wherein the history indicates one or more dates and delivery windows of delivery orders placed by the customer, and indicates information of one or more goods included in the delivery orders; and
generating the feature data based on the speed profile, location data, and history of the customer.

19. The computer program product of claim 17, wherein the generating the feature data further comprises generating feature data based on at least one of a dwelling-type of the delivery location and a time period the delivered order was delivered, and
wherein the timestamps of the two events comprise a timestamp associated with a time when an ignition of a delivery vehicle transporting the delivery order in an off-state and a timestamp associated with a time when the ignition of the delivery vehicle is in an on-state.

20. The computer program product of claim 17 wherein the program instructions further comprise:
receiving delivery orders to the one or more delivery locations,
wherein generating the planned delivery route further comprises allocating the received delivery orders to one or more delivery vehicles based on the one or more delivery locations, requested deliver windows to receive the delivery order, and the door-step time predictions corresponding to the one or more delivery locations.
